(19) United States
(12) Patent Application Publication
(10) Pub. No.: US 2024/0205820 A1
(43) Pub. Date: Jun. 20, 2024

(54) DYNAMIC AND INDEPENDENT POWER SAVING FOR A GATEWAY DEVICE

(71) Applicant: ARRIS Enterprises LLC, Horsham, PA (US)

(72) Inventor: Matthew S. BROOKS, Cumming, GA (US)

(21) Appl. No.: 18/539,573

(22) Filed: Dec. 14, 2023

Related U.S. Application Data
(60) Provisional application No. 63/433,135, filed on Dec. 16, 2022.

(51) Int. Cl. H04W 52/02

(52) U.S. Cl. CPC H04W 52/0203

(57) ABSTRACT

A power saving event can be triggered to cause a gateway device to alter one or more operations of the gateway device based on one or more power saving parameters associated with the power saving event. The gateway device can determine that a power saving feature is enabled. When the gateway device determines that a power saving event has been triggered, the gateway device can determine one or more power saving parameters associated with the power saving event. Based on the power saving event and the associated one or more power saving parameters, the gateway device can alter one or more operations of the gateway device to place the gateway device in a low power mode so as conserve resources. In response to a power saving event, gateway device can also reset one or more settings to a previous setting, a default configuration, or both.

### BACKGROUND

Many home networks include gateway devices that operate according to one or more protocols, for example, the Data Over Cable Service Interface Specification (DOCSIS), various Passive Optical Network (PON), such as DOCSIS over PON (D-PON), asynchronous transfer mode (ATM) PON (APON), broadband PON (BPON), Ethernet PON (EPON), etc., and the PacketCable standard to connect a local area network (LAN) to a cable modem termination system (CMTS) of a headend. Many such protocols include one or more power saving requirements for the wide area network (WAN) side interface of a gateway device. Therefore, there is a need to provide dynamic and independent power saving for LAN one or more side elements of the gateway device so as to reduce power consumption.

### SUMMARY

According to aspects of the present disclosure there are provided novel solutions for providing power saving at a LAN side of a gateway device. A gateway device during one or more intervals, such as a duration of time, can experience low to zero activity on one or more ports. Implementation of a power saving feature during these one or more intervals can reduce overall power consumption of the gateway device resulting in conservation of resources, such as lowering costs associated with operation of the gateway device. Generally such power saving features are instituted on the WAN side of the gateway device. However, one or more novel solutions of the present disclosure provide for power saving for a gateway device based on one or more power saving parameters associated with a power saving event, such as a determination that a port is idle for a period of time or that a radio is no longer needed.

An aspect of the present disclosure provides a gateway device for altering an operation of a gateway device based on one or more power saving parameters associated with a power saving event. The gateway device comprises a memory storing one or more computer-readable instructions, and a processor configured to execute the one or more computer-readable instructions to cause the gateway device to determine that a power saving feature is enabled, determine that a power saving event has been triggered, determine one or more power saving parameters associated with the power saving event, and alter one or more operations of the gateway device based on the one or more power saving parameters associated with the power saving event.

In an aspect of the present disclosure, the processor is further configured to execute the one or more computer-readable instructions to cause the gateway device to further determine to reset one or more settings of the gateway device based on the power saving event.

In an aspect of the present disclosure, the power saving event is triggered by any of a determination that the wide area network (WAN) network interface is idle, a receipt of a command, a comparison of an environmental parameter to an associated threshold, expiration of a timer, or any combination thereof.

In an aspect of the present disclosure, altering the one or more operations of the gateway device comprises setting an automatic negotiation with a low power maximum link speed for a link of a port based on the one or more power saving parameters.

In an aspect of the present disclosure, altering the one or more operations of the gateway device comprises bouncing the link of the port.

In an aspect of the present disclosure, altering the one or more operations of the gateway device comprises powering off a radio of the gateway device based on the one or more power saving parameters.

In an aspect of the present disclosure, altering the one or more operations of the gateway device comprises setting a radio to an energy management (EM) 1×1 antenna chain configuration.

An aspect of the present disclosure provides a method for a gateway device to alter an operation of the gateway device based on one or more power saving parameters associated with a power saving event. The method comprises determining that a power saving feature is enabled, determining that a power saving event has been triggered, determining one or more power saving parameters associated with the power saving event, and altering one or more operations of the gateway device based on the one or more power saving parameters associated with the power saving event.

In an aspect of the present disclosure, the method further comprises determining to reset one or more settings of the gateway device based on the power saving event.

In an aspect of the present disclosure, the method is such that the power saving event is triggered by any of a determination that the wide area network (WAN) network interface is idle, a receipt of a command, a comparison of an environmental parameter to an associated threshold, expiration of a timer, or any combination thereof.

In an aspect of the present disclosure, the method is such that altering the one or more operations of the gateway device comprises setting an automatic negotiation with a low power maximum link speed for a link of a port based on the one or more power saving parameters.

In aspect of the present disclosure, the method is such that altering the one or more operations of the gateway device comprises bouncing the link of the port.

In aspect of the present disclosure, the method is such that altering the one or more operations of the gateway device comprises powering off a radio of the gateway device based on the one or more power saving parameters.

In an aspect of the present disclosure, the method is such that altering the one or more operations of the gateway device comprises setting a radio to an energy management (EM) 1×1 antenna chain configuration.

An aspect of the present disclosure provides a non-transitory computer-readable medium of a gateway device storing a program for altering operation of the gateway device based on one or more power saving parameters associated with a power saving event. The program when executed by a processor of the gateway device, causes the gateway device to perform one or more operations including the steps of the methods described above.

The above-described novel solution may be implemented at a gateway device coupled to a multiple system operator (MSO) network so as to, when triggered by a power saving event, alter an operation of the gateway device based on one or more power saving parameters associated with a power saving event so as to conserve resources at the gateway device. Thus, according to various aspects of the present disclosure described herein, it is possible for a gateway device to dynamically and independently alter an operation of the gateway device so as to conserve resources associated with power usage by the gateway device.

### BRIEF DESCRIPTION OF DRAWINGS

In the drawings, like reference numbers generally indicate identical, functionally similar, and/or structurally similar elements.

FIG. 1 is a schematic diagram of a multiple system operator (MSO) network, according to one or more aspects of the present disclosure;

FIG. 2 is a more detailed block diagram illustrating various components of an exemplary gateway device, according to one or more aspects of the present disclosure;

FIGS. 3A and 3B are flow charts illustrating a method for altering an operation of the gateway device based on one or more power saving parameters associated with a power saving event, according to one or embodiments of the present disclosure; and

FIG. 4 illustrates a method for altering an operation of the gateway device based on one or more power saving parameters associated with a power saving event, according to one or embodiments of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

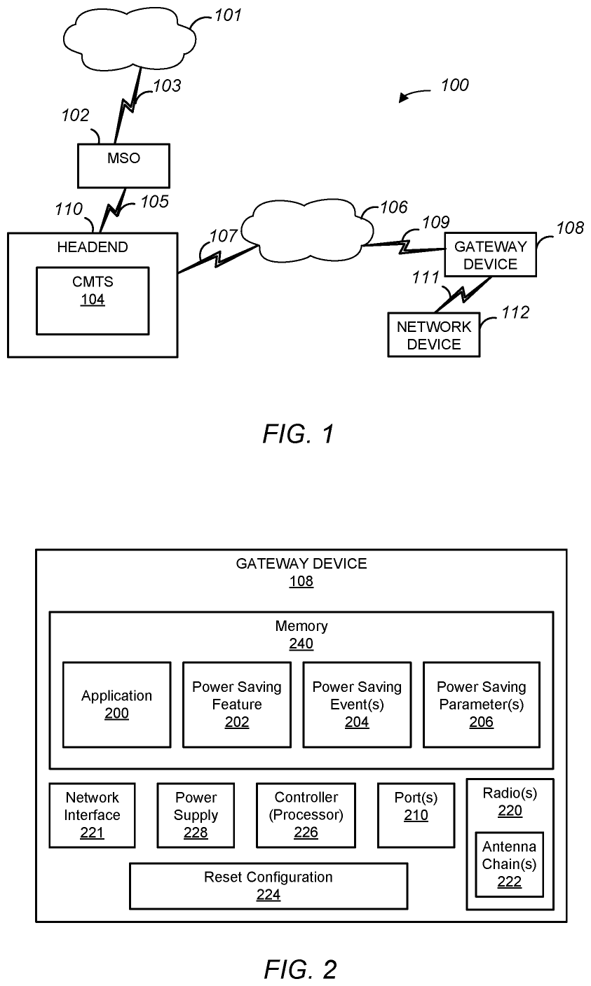

FIG. 1 is a schematic diagram of a multiple service (or system) operator (MSO) network, according to one or more aspects of the present disclosure. It should be appreciated that various example embodiments of inventive concepts disclosed herein are not limited to specific numbers or combinations of devices, and there may be one or multiple of some of the aforementioned electronic apparatuses in the system, which may itself consist of multiple communication networks and various known or future developed wireless and/or wired connectivity technologies, protocols, devices, and the like.

As shown in FIG. 1, an MSO network 100 comprises an MSO 102, for example, a cable network system operator, connected to a content provider or network resource 101 such as any of an Internet service provider (ISP) or programming provider, a cloud service, a repository, any other Internet-based service or provider, or any combination thereof. In one or more embodiments, the content provider 101 receives content from any source and transmits the content to an MSO 102, for example, via a connection 103 using any of a coaxial cable, a fiber optic cable, any other cabling system, a wireless system, a satellite, or combinations thereof. The MSO 102 can comprise or be connected to a headend 110 that comprises a cable mobile termination system (CMTS) 104 via a connection 105. The CMTS 104 can be located within, at or about a headend 110 or separate from the headend 110. The CMTS 104, the headend 110 or both can be part of or included within the MSO 102, for example. The headend 110 can utilize any one or more protocols for communication of data and/or information by any one or more network devices 112 within the MSO network 100, such as any of Data Over Cable Service Interface Specification (DOCSIS) via the CMTS 104, various Passive Optical Network (PON), such as DOCSIS over PON (D-PON), asynchronous transfer mode (ATM) PON (APON), broadband PON (BPON), Ethernet PON (EPON), etc., the PacketCable standard, any other protocol and/or standard, or any combination thereof.

The content provider or network resource 101 can be, for example, a streaming video provider or any computer for connecting the MSO 102 to any content source. Any one or more of the connections 107 and 109 between the CMTS 104 and the gateway device 108 can be implemented using a DOCSIS network and/or a fiber optics network (for example, FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

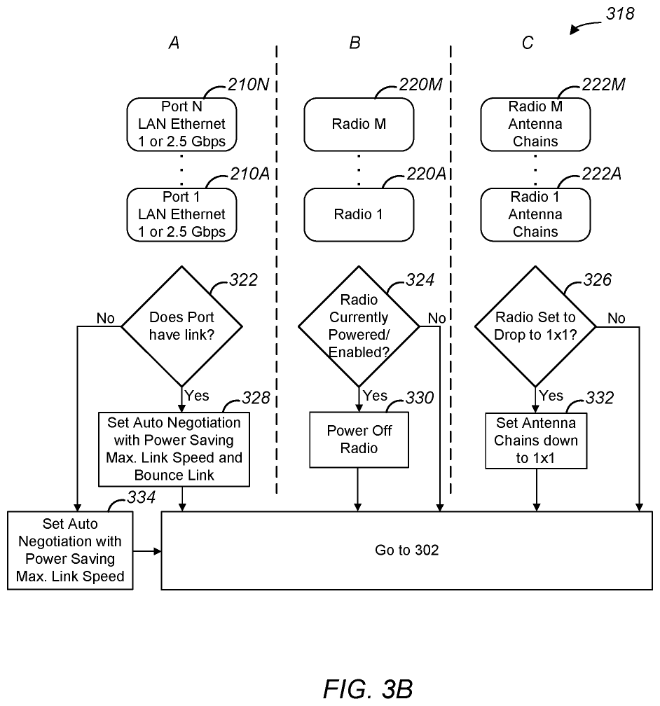

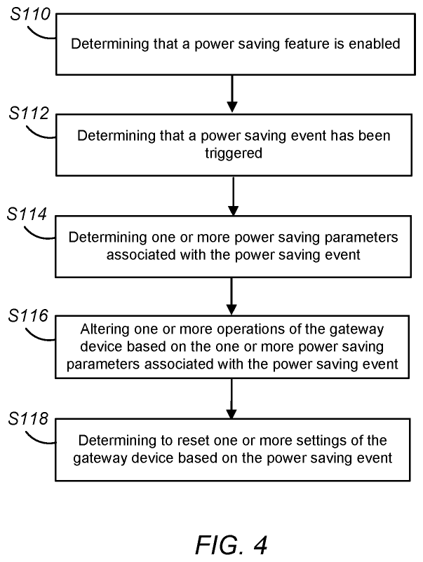

The CMTS 104, the headend 110 or both are connected directly or indirectly via connection 107 to a network 106, such as any of a hybrid fiber coaxial (HFC) network, a passive optical network (PON), any other network, or a combination thereof. The network 106 connects to a gateway device 108 via a connection 109. For example, the CMTS 104, the headend 110 or both can communicate a power management response that indicates permission or approval for the gateway device 108 to alter one or more operations of the gateway device 108 for power saving in response to the gateway device 108 sending a power management request to the CMTS 104, the headend 110, or both that indicates that the gateway device 108, for example, the WAN interface of the gateway device 108, is “Idle” or not being utilized at or above a threshold to the gateway device 108. In another example, the gateway device 108 can determine that the WAN interface is “Idle” and send a power management request to the CMTS 104, the headend 110, or both and after sending the power management request, the gateway device 108 can alter one or more operations as discussed with respect to FIGS. 3A, 3B and 4. In another example, the gateway device 108 can receive a command so as to force the gateway device 108 to alter one or more operations of the gateway device 108 as discussed with respect to FIGS. 3A, 3B and 4.

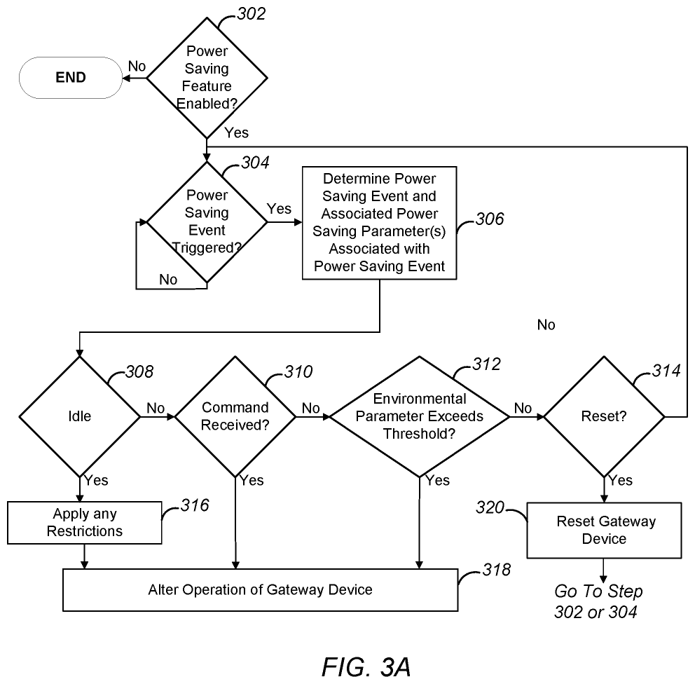

The gateway device 108 can comprise, for example, a modem, a gateway (such as any of a residential gateway (RG), a broadband access gateway, a home network gateway, any other gateway, or any combination thereof), a network device that combines the functions of a modem, a router, and/or any other network device, an access point (AP), a router, an extender access point, an Internet Protocol/Quadrature Amplitude Modulator (IP/QAM) set-top box (STB) or smart media device (SMD), any other network device capable of altering operation of the gateway device 108 based on one or more power saving parameters associated with a power saving event (for example, when a power saving feature is enabled for the gateway device 108, or any combination thereof. A detailed description of the exemplary internal components of the gateway device 108 shown in FIG. 1 will be provided in the discussion of FIG. 2. However, in general, it is contemplated by the present disclosure that the gateway device 108 includes electronic components or electronic computing devices operable to receive, transmit, process, store, and/or manage data and information associated with the MSO network 100, which encompasses any suitable processing device adapted to perform computing tasks consistent with the execution of computer-readable instructions stored in a memory or a computer-readable recording medium (for example, a non-transitory computer-readable medium). Further, any, all, or some of the computing components in the gateway device 108 can be adapted to execute any operating system, including Linux, UNIX, Windows, MacOS, DOS, and ChromOS as well as virtual machines adapted to virtualize execution of a particular operating system, including customized and proprietary operating systems. The gateway device 108 is further equipped with components to facilitate communication with other network devices 112 over any network enabling communication in the MSO network 100.

The gateway device 108 can communicate with a network device 112 via a connection 111. The connection 111 can be a wired and/or wireless connection implanted through any one or more protocols. For example, the gateway device 108 can communicate with a network device 112 using any of Data Over Cable Service Interface Specification (DOCSIS), various Passive Optical Network (PON), such as DOCSIS over PON (D-PON), asynchronous transfer mode (ATM) PON (APON), broadband PON (BPON), Ethernet PON (EPON), etc., the PacketCable standard, any other protocol and/or standard, or any combination thereof. A network device 112 can comprise any of a client device, an access point, an extender access point, any other network device, or any combination thereof.

FIG. 2 is a more detailed block diagram illustrating various components of an exemplary gateway device 108 in the MSO network 100 of FIG. 1, according to some example embodiments. Although FIG. 2 only shows one gateway device 108, the gateway device 108 shown in the figure is meant to be representative of one or more gateway devices 108 of a network system, for example, MSO network 100 shown in FIG. 1. The connection 109 between the gateway device 108 and the network 106 and the connection 107 between the network 106 and the CMTS 104 shown in FIG. 2 are meant to be exemplary connections and are not meant to indicate all possible connections between these components or elements, for example, the present disclosure contemplates indirect and direct connections. Additionally, it is contemplated by the present disclosure that the number of gateway devices 108 is not limited to the number shown in FIGS. 1 and 2.

Now referring to FIG. 2, the gateway device 108 can comprise any of a controller (or processor) 226, a memory 240, a network interface 221, a power supply 228, one or more ports 210, one or more radios 220, a reset configuration 224, or any combination thereof. The gateway device 108 can be, for example, a network device that can combine one or more functions of any one or more network devices 112 as discussed above with reference to FIG. 1. The power supply 228 supplies power to the internal components of the gateway device 108. The power supply 228 can be a self-contained power source such as a battery pack with an interface to be powered through an electrical charger connected to an outlet (for example, either directly or by way of another device). The power supply 228 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 221 can comprise, but is not limited to, various network cards, interfaces, and circuitry implemented in software and/or hardware to enable communications with any of the headend 110, the CMTS 104, a network 106, an MSO 102, any other element or component of MSO network 100 using the communication protocols in accordance with any of connections 109, 107, 105 or a combination thereof (for example, as described with reference to FIG. 1), or any combination thereof. For example, the network interface 221 may include various network cards, and circuitry implemented in software and/or hardware to enable communications with network 106 using the communication protocols in accordance with connection 109 (for example, as described with reference to FIG. 1, such as DOCSIS, PON, etc.). For example, the network interface 221 can comprise any of a WAN interface, a LAN interface, multimedia over Coaxial alliance (MoCA) interface, any other network interface or any combination thereof. A network interface 221 can be associated with one or more ports 210.

The memory 240 can comprise a single memory or one or more memories or memory locations that include, but are not limited to, a random access memory (RAM), a dynamic random access memory (DRAM), a memory buffer, a hard drive, a database, an erasable programmable read only memory (EPROM), an EEPROM, a read only memory (ROM), a flash memory, logic blocks of a field programmable gate array (FPGA), hard disk or any other various layers of memory hierarchy. The memory 240 can be a non-transitory computer-readable storage medium used to store any type of instructions, software, or algorithm including application or software 200 for power management of the gateway device 108 based on a power saving feature 202 stored in the memory 240. The power saving feature 202 can be enabled or disabled for the gateway device 108, for example, set to a binary “1” if enabled, and a binary “0” if not enabled. When one or more power saving events 204 are triggered, the application 200 can alter operation of the gateway device, for example, based on one or more power saving parameters 206, one or more power saving configurations 206, or any combination thereof. In one or more embodiments, the one or more of the power saving events 204, the one or more power saving parameters 206, and or both are stored locally in memory 240, in an external memory coupled to the gateway device 108, at a network resource (such as a cloud repository or an Internet repository), or any combination thereof.

The one or more ports 210 can comprise any one or more ports or interfaces that allows the gateway device 108 to communicate with one or more network devices 112, for example, one or more Ethernet ports. In one or more embodiments, the network interface 221 and the port 210 are part of a single element, multiple elements, or distinct from each other. One or more operations of the gateway device 108 associated with one or more ports 210 can be altered dynamically and independently from one another. The one or more radios 220 can be any of one or more 2.4 Gigahertz (GHz) radios, one or more 5 GHz radios, one or more 6 GHz radios, one or more Internet of Things (IOT) radios (for example, which utilize any of Bluetooth, Bluetooth Low Energy (BLE), Thread, Zigbee, Zwave, Matter, or any combination thereof), any other one or more radios, or any combination thereof. Each of the one or more radios 220 can comprise one or more antenna chains 222. A radio 220 can be permitted to operate, configured, or operational at one or more frequency bands.

The one or more power saving events 204 can indicate an event that is triggered based on power consumption or usage at the gateway device 108. For example, the one or more power saving events 204 can comprise a comparison of one or more network parameters (such as any of an idle time of the gateway device 108, a throughput, a number of connected network devices on a network interface 221, an analysis of type of network devices connected on a network interface 221, a timestamp (such as date and/or time), or any combination thereof) to a network threshold, sending a power management request to a CMTS 104, a headend 110, or both, receiving a power management response from a CMTS 104, a headend 110 or both, receiving a command (for example, any of a command line instruction (CLI), such as a database manager command line instruction (DMCLI), a management information base (MIB) instruction, a Technical Report (TR) 069/181 instruction, any other command or instruction, or any combination thereof), comparison of one or more environmental parameters (for example, ambient temperature) to an environmental threshold, expiration of a power saving timer, a reset, or any combination thereof.

Any one or more power saving events 204 can be associated with one or more power saving parameters 206. The one or more power saving parameters 206 are indicative of an operation of one or more elements of the gateway device 108, for example, such as any of one or more ports 210, one or more radios 220, one or more antenna chains 222 of one or more radios 220, a network interface 221, a controller or processor 226, or any combination thereof. The one or more power saving parameters 206 can comprise one or more restrictions (RE) (for example, a time, a day of week, a month, etc. that the gateway device 108 can be placed in power saving mode, such as that one or more pawer saving parameters 206 can be applied to alter operation of an element of the gateway device 108 only as specified), a radio power indicator (RPI) for a radio 220 (for example, that power to a particular radio 220 should be set to “OFF” or otherwise disconnected), an antenna chain configuration (ACC) (for example, that an antenna chain 222 for a particular radio 220 should be set to (for example, allowed to use) an energy management (EM) 1×1 (1 transmitter/1 receiver)) antenna chain configuration, a port configuration indicator (PCI) (for example, that a particular port 210 should be set to automatic negotiation with a predetermined or low power maximum link speed, such as 100 Megabits per second (Mbps), 10 Mbps, a default link speed, or a forced full duplex maximum link speed of 1000 Mbps, 100 Mbps or 10 Mbps so as to force half duplex communication with one or more other automatic negotiation network devices one or more ports 210), reset indicator (RI) (for example, that one or more configurations of a radio 220, a port 210, or both should be set to a prior configuration or a default configuration, such as at expiration of a power saving timer (such as a timer based on one or more power saving parameters indicative of one or more restrictions), one or more network interfaces 221 are no longer “Idle”, a processor down rating (for example, indicating that a controller processor 226 should be down rated so as to save power), or any combination thereof. For example, TABLE 1 illustrates one or more power saving parameters 206 associated with one or more power saving events 204. While TABLE 1 illustrates a certain power saving parameters 206 associated with certain power saving events 204, the present disclosure contemplates variations or combinations of TABLE 1. For example, if the gateway device 108 determines that a power saving event 204 has been triggered, for example, the WAN is “IDLE” (such as no traffic or a traffic level is below a threshold), and a power saving feature 202 is “ENABLED”, the gateway device 108 can determine one or more power saving parameters 206 associated with the power saving event 204 indicate that one or more operations of the gateway device 108 should be altered, for example, during the hours of midnight (24:00:00) to 4:00 AM (04:00:00) when the day of week is a Monday (M), Tuesday (T), Wednesday (W), Thursday (R) or Friday (F) that a first radio “x” should be turned to “OFF” (radio “x” should not power up one or more radio frequency (RF) gain blocks and/or transmit/receive any one or more frames), that the maximum link speed of a link for a port “m” should be set to 100 Mbps, for example, for Ethernet or MoCA. For TABLE 1 below, “m”, “n”, “N” and “x” represent any number associated with an element of the gateway device 108, for example, a first, second, etc., such as a first radio, a second radio, etc., or a number, such as port 1, port 2, etc. The gateway device 108 can dynamically and independently alter one or more operations of the gateway device based on the one or more power saving parameters 206 associated with the power saving event 204. For example, one or more operations of a radio 220, an antenna chain 222 of a radio 220, a port 210 can be altered dynamically and independently of any other altering of one or more operations.

TABLE 1

| Power Saving Event | | | | |
|---|---|---|---|---|
| | Receive | Receive | Temperature | Expiration |
| Determine | Power | Command to | Above | of Power |
| WAN is | Management | Enter Power | Temperature | Saving |
| “IDLE” | Response | Saving Mode | Threshold | Timer |

| | | | | | |
|---|---|---|---|---|---|
| Power | RPI | Turn “OFF” | Turn “OFF” | Turn “OFF” | |
| Saving | | Radio “x” | Radio “x” | Radio “x” − | |
| Parameter | | | | “N” | |
| | ACC | | Set Radio “x” | | |
| | | | ACC to EM | | |
| | | | 1 × 1 chain | | |
| | PCI | Set Max | Set Max Link | | |
| | | Link Speed | Speed to 100 | | |
| | | to 100 Mbps | Mbps for Port | | |
| | | for Port “m” | “m” − “n” | | |
| | RI | | | | Reset all |
| | | | | | ports and |
| | | | | | radios to |
| | | | | | default |
| | RE | 24:00:00 to | | | |
| | | 04:00:00 | | | |
| | | MTWRF | | | |

The controller or processor 226 controls the general operations of the gateway device 108 as well as performs management functions related to communications to and from the headend 110, the CMTS 104, or both via network 106. For example, the gateway device 108 can communicate information upstream to the headend 110, the CMTS 104 or both and receive information downstream from the headend 110, the CMTS 104 or both. The controller 226 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the application 200 for altering an operation of the gateway device 108 based on one or more power saving parameters 206 associated with a power saving event 204, for example, when a power saving feature is enabled for the gateway device 108. The controller 226 may also be referred to as a processor, generally.

The reset configuration 224 can indicate a default configuration or one or more settings of one or more elements (such as any of one or more network interfaces 221, one or more ports 210, one or more radios 220, one or more antenna chains 222 of one or more radios 220, or any combination thereof). While the reset configuration 224 is illustrated as an element of the gateway device 108, the present disclosure contemplates that the reset configuration 224 can be stored locally (for example, any of a memory 240, a basic input/output system (BIOS), any other memory or storage location, or any combination thereof), remotely (for example, any of a network resource 101, a repository, an external memory, or any combination thereof), or both. For example, when the power saving event 204 comprises a reset indicator or is indicative of a reset, the gateway device 108 can access, retrieve, or otherwise use the reset configuration 224 to alter one or more operations of the gateway device 108, such as by setting one or more settings of one or more elements of the gateway device 108 per the reset configuration 224. For example, the gateway device 108 can determine that the power saving event 204 requires reset of one or more settings of the gateway device 108 based on the one or more power saving parameters 206 associated with the power saving event 204. The gateway device 108 alters one or more operations of the gateway device 108 based on the one or more power saving parameters 206 by implementing the one or more settings indicated by the reset configuration 224.

FIGS. 3A and 3B are flow charts illustrating a method for altering an operation of the gateway device 108 based on one or more power saving parameters 206 associated with a power saving event 204, according to one or embodiments of the present disclosure, for example, when a power saving feature 202 is enabled for the gateway device 108.

FIGS. 3A, 3B and 4 illustrate a method for a gateway device 108 that may be an electronic device programmed with one or more instructions (for example, software or application 200) to perform steps for altering an operation of the gateway device 108 based on one or more power saving parameters 206 associated with a power saving event 204, according to one or embodiments of the present disclosure. In FIGS. 3A, 3B and 4 it is assumed that the gateway device 108 includes one or more controllers and their respective software stored in one or more respective memories, as discussed above in reference to FIGS. 1-2, which when executed by their respective controllers perform the functions and operations in accordance with the example embodiments of the present disclosure (for example, including software or application 200).

The gateway device 108 comprises a controller or processor 226 that executes one or more computer-readable instructions, stored on a memory 240, that when executed perform one or more of the operations of the steps 302-334 of FIGS. 3 and 3B and steps S110-S118 of FIG. 4 In one or more embodiments, the one or more instructions may be one or more software applications, for example, one or more software or applications 200. While the steps 302-334 of FIGS. 3A and 3B and steps S110-S118 of FIG. 4 are presented in a certain order, the present disclosure contemplates that any one or more steps can be performed simultaneously, substantially simultaneously, repeatedly, in any order or not at all (omitted).

At step 302, the gateway device 108 determines whether a power saving feature 202 of the gateway device 108 is enabled. For example, the gateway device can request from memory 240 a setting stored in the memory 240 or any other non-volatile storage that indicates whether the power saving feature 202 is enabled. If the power saving feature 202 is not enabled, the process ends. If the power saving feature 202 is enabled, the gateway device 108 at step 304 determines whether a power saving event 204 has been triggered. For example, a power saving event 204 can be triggered by any of a determination by the gateway device 108 that the gateway device 108 is “Idle” (such as any of the gateway device 108 determines that the WAN interface is “Idle” via EM 1×1 antenna chain configuration logic triggered, sending a power management request to the CMTS 104, the headend 110, or both after determining that the WAN interface is “Idle”, receiving a power management response that indicates that the gateway device 108 is “Idle” or not being utilized at or above a threshold in response to the gateway device 108 sending a power management request to the CMTS 104, the headend 110, or both after determining that the WAN interface is “Idle”, any other WAN interface activity “Idle” discovery triggered, or any combination thereof), receiving a command, a determination that an environmental parameter exceeds a threshold, any other trigger, or any combination thereof. For example, a determination that a WAN interface is “Idle” can be based on a configuration file stored in a memory 240, such as one or more settings and/or thresholds of the configuration file. As an example, if the WAN interface experiences less than 1.50 Mbps downstream traffic continuously for a downstream time period (such as thirty seconds) and less than 0.5 Mbps upstream continuously for an upstream time period (such as thirty seconds), then the gateway device 108 can determine that the WAN interface is not “Idle” and the WAN interface can be reset, for example, exit the EM 1×1 antenna chain configuration and return to the previous configuration.

At step 306, the gateway device 108 determines the power saving event 204 that was triggered and one or more power saving parameters 206 associated with the power saving event 204. For example, the gateway device 108 can determine at step 308 that the gateway device 108 is “Idle” (such as in an “Idle” state), for example, as discussed with step 304 and then proceed to step 316 where one or more restrictions are applied. For example, the gateway device can determine whether the one or more power saving parameters 206 comprise one or more restrictions. The one or more restrictions can limit alteration of one or more operations of the gateway device 108 when the power saving feature 202 is enabled to, for example, a time, a day of week, a month, a year, any other date and/or time combination, or any combination thereof. For example, if no restrictions are applicable for the gateway device (such as none of the one or more power saving parameters 206 indicate a restriction or the gateway device 108 meets the one or more restrictions, for example, the current date and/or time is not restricted), the process continues to step 318.

If the power saving event 204 is not determined to be an “Idle” state at 308, the process can continue to step 310. A power saving event 204 can be triggered by the gateway device 108 receiving a command. For example, a manual set option command can be received by the gateway device 108 that causes or forces the gateway device 108 to put the LAN interface in LAN low power mode (LLPM). The command, for example, can comprise a DMCLI command, a MIB command, TR069/181, a CLI command, any other command that forces the LAN to LLPM, or any combination thereof. The process can then continue to step 318. In one or more embodiments, a command can be received that forces a reset of the gateway device 108 as discussed with respect to steps 314 and 320.

If the power saving event 204 is determined not to be a command at step 310, then at step 312 the gateway device 108 can compare an environmental parameter to an associated threshold (for example, the gateway device 108 can determine whether an environmental parameter is at or above an associated threshold). For example, an environmental parameter can comprise any of a temperature (such as any of ambient temperature, System on Chip (SoC) silicon temperature, Wi-Fi radio chip silicon temperature, any other temperature associated with any other element of the gateway device 108, or any combination thereof), a temperature associated with a time period, a fan speed, a fan speed associated with a time period, a fan noise, a fan noise associated with a time period, or any combination thereof. So as to prevent or delay a complete shutdown of a network interface 221 (for example, a WAN interface and/or a LAN interface), the gateway device 108 can detect or determine that a temperature associated with the gateway device 108 is at or exceeds an associated threshold. In this way, the gateway device 108 remains operational while the gateway device 108 attempts to lower the temperature associated with the gateway device 108 by implementing a lower power mode of one or more network interfaces 221 as discussed with reference to step 318.

If the power saving event 204 is determined not to be triggered by a comparison of an environmental parameter to a threshold, then at step 314 the gateway device 108 determines whether the power saving event 204 is a reset, such as an indicator or a command to reset the gateway device 108, for example, to reset one or more settings of the gateway device 108. The power saving event 204 to reset the gateway device 108 can be that the gateway device 108 determines that the WAN interface is not “Idle” and thus the gateway device 108 must exit from a low power mode, for example, from DOCSIS EM 1×1 antenna chain configuration logic, or that any other WAN activity is not “Idle” discovery is triggered. If the power saving event 204 is determined to be a reset, then at step 320, the gateway device 108 resets the gateway device 108. For example, the gateway device 108 can reset any of the network interface 221, one or more radios 220, one or more antenna chains 222 of the one or more radios 220, one or more ports 210, or any combination thereof. The resetting the gateway device 108 can be based on a reset configuration 224. The reset configuration 224 can comprise one or more default settings and/or one or more previous settings for any one or more elements of the gateway device 108, such as any of a network interface 221, a port 210, a radio 220, an antenna chain 222 of a radio 220, or any combination thereof. For example, the one or more power saving parameters 206 can indicate that a particular reset configuration 224 should be implemented, that one or more low power mode setting previously implemented should be undone, or both. For example, the gateway device 108 can wait for an exit low power mode event to return the gateway device 108 to one or more previous settings or one or more default settings, for example, to reset to a maximum link speed possible (such as based on an maximum Ethernet automatic negotiated rates list) to a default state or a previous state (for example, altering the maximum link speed from a low power maximum link speed to a previous or default maximum link speed), return to a default state or a previous state for power at a radio 220, return to default state or previous state for an antenna chain 222 of a radio 220, or any combination thereof. After reset of the gateway device is complete, the process can continue at either step 302 or step 304.

If at any of steps 308 after applying any restrictions at step 316, 310, 312, or any combination thereof, the power saving event 204 is determined, the process continues to step 318. At step 318, the gateway device 108 alters one or more operations of the gateway device 108 based on the one or more power saving parameters 206 associated with the power saving event from step 306. For example, step 318 can comprise altering one or more operations as illustrated and discussed with reference to FIG. 3B.

FIG. 3B illustrates a flowchart for altering one or more operations of a gateway device 108 at step 318. As an example, the one or more power saving parameters 206 can indicate that one or more operations of one or more ports 210A-210N (collectively, one or more ports 210), where “N” represents any number, should be altered, as illustrated in Example A. The one or more ports 210 can be any of a LAN Ethernet 1 Gbps, a 2.5 Gbps, any other type of port, or any combination thereof. For example, at step 322, the gateway device 108 determines whether any of the one or more ports 210 or one or more network interfaces 221 associated with the one or more ports 210 have a link. If so, the gateway device 108 at step 328 sets the automatic negotiation with a power saving maximum link speed and bounces (for example, disconnect and reconnect a network device connected to the associated port 210) the link (for example, an Ethernet link) based on the one or more power saving parameters 206. If not, the gateway device 108 at step 334 sets the automatic negotiation with a power saving maximum link speed and no bounce is necessary as no link exists. In one or more embodiments, the power saving maximum link speed at 328 and/or 334 is set to less than the previously set maximum link speed or the default maximum link speed. For example, a power saving maximum link speed can be 100 Mbps or 1000 Mbps while the previous or default maximum link speed can be 1000 Mbps or 1 Gigabits per second (Gbps), respectively. In one or more embodiments, a command received at step 310 can force one or more ports 210 or associated one or more network interfaces 221 to a power saving maximum link speed at half duplex The process continues after steps 328 and/or 334 to step 302.

As an example, the one or more power saving parameters 206 can indicate that one or more operations of one or more radios 220A-220M (collectively, one or more radios 220), wherein “M” represents any number, should be altered, as illustrated in Example B. The one or more radios 220 can be any of one or more 2.4 GHz radios, one or more 5 GHz radios, one or more 6 GHz radios, one or more IoT radios, any one or more other radios or any combination thereof. At step 324, the gateway device 108 can determine whether any of the one or more radios 220 currently have powered transmit (TX) and/or receive (RX) and if so, at step 330, the gateway device 108 can turn off power to the one or more radios 220 based on the one or more power saving parameters 206 and the process continues to step 302. In one or more embodiments, the gateway device 108 can determine that the one or more parameters 206 indicate that one or more frequency bands associated with any one or more radios 220 are restricted.

As an example, the one or more power saving parameters 206 can indicate that one or more operations of one or more radio antenna chains 222A-222M of the one or more radios 220A-220M should be altered, as illustrated in Example C. At step 326, the gateway device 108 can determine if any one or more antenna chains 222A-222M are set to drop to an EM 1×1 antenna chain configuration based on one or more power saving parameters 206, and if so, at step 332, the gateway device 108 can instruct, allow or otherwise give permission for a radio 220 to set associated one or more antenna chains 222 to an EM 1×1 antenna chain configuration based on the one or more power saving parameters 206. If none of the one or more radios 220 are set to drop to an EM 1×1 antenna chain configuration, the process continues to step 302.

In this way, the gateway device 108 can sustain an acceptable level of QoS and conserve resources by altering one or more operations of the gateway device 108 based on one or more power saving parameters 206 associated with a triggered of a power saving event 204. While FIGS. 3A and 3B illustrates steps 308-314 implemented in a certain order, the present disclosure contemplates that any of these steps can be implemented in any order, simultaneously or substantially simultaneously, or omitted.

FIG. 4 illustrates a method for altering an operation of the gateway device based on one or more power saving parameters associated with a power saving event, according to one or embodiments of the present disclosure. At step S110, the gateway device 108 determines that a power saving feature is enabled 202 is enabled. The power saving feature 202 can be stored in any of a memory 240 of the gateway device 108, remote from the gateway device 108, such as at a network resource 110, any other memory, or any combination thereof. The power saving feature 202 when enabled indicates that the gateway device 102 is permitted to alter one or more operations of the gateway device 108 so as to save power, for example, to reduce the power usage by the gateway device 108.

At step S112, the gateway device 108 determines that a power saving event has been triggered. The gateway device 108 can monitor or otherwise listen for a triggering event (such as an interrupt) when the power saving feature is enabled. In one or more embodiments, the gateway device 108 performs one or more steps of the method of FIG. 4 substantially simultaneously with or at the determination at step S112, within a certain time period of the triggered event, at expiration of a timer, or any combination thereof. The gateway device can determine the power saving event dynamically such that user intervention is not required. In one or more embodiments, the power saving event is triggered by any of a determination that the wide area network (WAN) network interface is idle, a receipt of a command, a comparison of an environmental parameter to an associated threshold, expiration of a timer, or any combination thereof.

At step S114, the gateway device 108 determines one or more power saving parameters 206 associated with the power saving event 204. The one or more power saving parameters 206 are indicative of one or more operations of the gateway device that can be altered as a result of the power saving event 204 being triggered. Any of the one or more power saving parameters 206, the one or more power saving events 204, the power saving feature 202, or any combination thereof can be stored as part of a database, a repository, a flat-file system, any other storage system, or any combination thereof.

At step S116, the gateway device 108 alters one or more operations of the gateway device 108 based on the one or more power saving parameters 206 associated with the power saving event 204. The gateway device 108 can alter one or more operations dynamically without any user intervention and independently of altering any other one or more operations. In one or more embodiments, the altering the one or more operations of the gateway device 108 comprises any of setting an automatic negotiation with a low power maximum link speed for a link of a port based on the one or more power saving parameters, bouncing the link of the port, powering off a radio of the gateway device based on the one or more power saving parameters, setting a radio 220 to an EM 1×1 antenna chain configuration, or any combination thereof. Setting a radio 220 to an EM 1×1 antenna chain can comprise the gateway device 108 instructing, allowing or otherwise giving permission for a radio 220 to use EM 1×1 antenna chain configuration. In one or more embodiments, the gateway device 108 maintains a power saving log of each of the one or more operations altered. For example, the power saving log, such as a reset configuration 224, can comprise any of a timestamp, a power saving event 204 that was triggered, an operation, an element associated with the operation, a current state of the element (for example, one or more current settings associated with the operation of the element), any other information, or any combination thereof. The power saving log of the gateway device 108 can be used, for example, for any of resetting the gateway device 108 as discussed with reference to steps 314 and 320 of FIG. 3A, statistical analysis of one operations associated with a power saving event 204, any other analysis, or any combination thereof.

At step S118, the gateway device 108 can determine to reset one or more settings of the gateway device 108 based on the power saving event. In one or more embodiments, the gateway device 108 can wait or otherwise delay resetting based on a reset time period. For example, resetting the gateway device 108 can be delayed for a power saving duration (a set length of time that a gateway device 108 cannot be transition from power saving so as to prevent excessive toggling).

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A gateway device for altering an operation of the gateway device based on one or more power saving parameters associated with a power saving event, comprising:
a memory storing one or more computer-readable instructions; and
a processor configured to execute the one or more computer-readable instructions to cause the gateway device to:
determine that a power saving feature is enabled;
determine that a power saving event has been triggered;
determine one or more power saving parameters associated with the power saving event; and
alter one or more operations of the gateway device based on the one or more power saving parameters associated with the power saving event.

2. The gateway device of claim 1, wherein the processor is further configured to execute the one or more computer-readable instructions to further cause the gateway device to:
determine to reset one or more settings of the gateway device based on the power saving event.

3. The gateway device of claim 1, wherein the power saving event is triggered by any of a determination that the wide area network (WAN) network interface is idle, a receipt of a command, a comparison of an environmental parameter to an associated threshold, expiration of a timer, or any combination thereof.

4. The gateway device of claim 1, wherein altering the one or more operations of the gateway device comprises:
setting an automatic negotiation with a low power maximum link speed for a link of a port based on the one or more power saving parameters.

5. The gateway device of claim 4, wherein altering the one or more operations of the gateway device comprises:
bouncing the link of the port.

6. The gateway device of claim 1, wherein altering the one or more operations of the gateway device comprises:
powering off a radio of the gateway device based on the one or more power saving parameters.

7. The gateway device of claim 1, wherein altering the one or more operations of the gateway device comprises:
setting a radio to an energy management (EM) 1×1 antenna chain configuration.

8. A method for a gateway device to alter an operation of the gateway device based on one or more power saving parameters associated with a power saving event, the method comprising:
determining that a power saving feature is enabled;
determining that a power saving event has been triggered;
determining one or more power saving parameters associated with the power saving event; and
altering one or more operations of the gateway device based on the one or more power saving parameters associated with the power saving event.

9. The method of claim 8, further comprising:
determining to reset one or more settings of the gateway device based on the power saving event.

10. The method of claim 8, wherein the power saving event is triggered by any of a determination that the wide area network (WAN) network interface is idle, a receipt of a command, a comparison of an environmental parameter to an associated threshold, expiration of a timer, or any combination thereof.

11. The method of claim 8, wherein altering the one or more operations of the gateway device comprises:
setting an automatic negotiation with a low power maximum link speed for a link of a port based on the one or more power saving parameters.

12. The method of claim 11, wherein altering the one or more operations of the gateway device comprises:
bouncing the link of the port.

13. The method of claim 8, wherein altering the one or more operations of the gateway device comprises:
powering off a radio of the gateway device based on the one or more power saving parameters.

14. The method of claim 8, wherein altering the one or more operations of the gateway device comprises:
setting a radio to an energy management (EM) 1×1 antenna chain configuration.

15. A non-transitory computer-readable medium of a gateway device storing a program for altering an operation of the gateway device based on one or more power saving parameters associated with a power saving event, which when executed by a processor of the gateway device, causes the gateway device to perform one or more operations comprising:
determining that a power saving feature is enabled;
determining that a power saving event has been triggered;
determining one or more power saving parameters associated with the power saving event; and
altering one or more operations of the gateway device based on the one or more power saving parameters associated with the power saving event.

16. The computer-readable medium of claim 15, wherein the program, when executed by the processor, further causes the gateway device to perform one or more further operations comprising:
determining to reset one or more settings of the gateway device based on the power saving event.

17. The computer-readable medium of claim 15, wherein the power saving event is triggered by any of a determination that the wide area network (WAN) network interface is idle, a receipt of a command, a comparison of an environmental parameter to an associated threshold, expiration of a timer, or any combination thereof.

18. The computer-readable medium of claim 15, wherein altering the one or more operations of the gateway device comprises at least one of:
powering off a radio of the gateway device based on the one or more power saving parameters; and
setting a radio to an energy management (EM) 1×1 antenna chain configuration.

19. The computer-readable medium of claim 15, wherein altering the one or more operations of the gateway device comprises:
setting an automatic negotiation with a low power maximum link speed for a link of a port based on the one or more power saving parameters.

20. The computer-readable medium of claim 19, wherein altering the one or more operations of the gateway device comprises:
bouncing the link of the port.
